(19) United States
(12) Patent Application Publication
(10) Pub. No.: US 2018/0121544 A1
(43) Pub. Date: May 3, 2018

(54) APPARATUS AND METHOD FOR ENHANCING REGULAR EXPRESSION SEARCH PERFORMANCE THROUGH COST-BASED OPTIMIZATION TECHNIQUE

(71) Applicant: WINS Co., Ltd., Seongnam-si (KR)

(72) Inventors: HARKSU CHO, Seongnam-si (KR); YONGSIG JIN, Gunpo-si (KR); BRUCE NDIBANJE, Seoul (KR)

(73) Assignee: WINS Co., Ltd., Seongnam-si (KR)

(21) Appl. No.: 15/665,915

(22) Filed: Aug. 1, 2017

(30) Foreign Application Priority Data
Oct. 28, 2016 (KR) 10-2016-0142330

(51) Int. Cl. G06F 17/30; H04L 29/06

(52) U.S. Cl. CPC G06F 17/30864; G06F 17/30474; H04L 63/1416

(57) ABSTRACT

The present invention is directed to configure an effective search node based on splitting, regrouping, complexity calculation, and learning information, and perform high-performance regular expression search. To this end, the present invention includes: a policy database; a regular expression extraction processor; a regular expression fragment processor that splits each of the regular expression character strings extracted by the regular expression extraction processor in accordance with a fragmentation rule; a regular expression normalization processor that generates an optimized regular expression fragment table; a cost calculation engine processor that determines a cost for each of the regular expression fragments; a decision tree generation processor that generates a decision tree based on cost information; and a pattern matching engine processor that configures a search engine.

### CROSS-REFERENCE TO RELATED APPLICATIONS

This application claims the benefit of Korean Patent Application No. 10-2016-0142330, filed on Oct. 28, 2016, in the Korean Intellectual Property Office, the disclosure of which is incorporated herein in its entirety by reference.

### BACKGROUND OF THE INVENTION

### 1. Field of the Invention

The present invention relates to an apparatus and a method for enhancing regular expression search performance through a cost-based optimization technique, which configure an effective search node based on splitting, regrouping, complexity calculation, and learning information, and perform high-performance regular expression search.

### 2. Description of the Related Art

Snort is an open source library that can perform protocol analysis and payload pattern matching. Snort is widely used because Snort can generate and operate a Snort detection policy provided by Snort itself and can also allow a user to generate and operate a customized policy. In addition, Snort utilizes such advantages even in a plurality of intrusion detection systems to perform packet inspection by using a Snort syntax so as to determine aggression of an irregular character string.

The Snort syntax maximizes flexibility of matching by supporting regular expressions as well as options related to character strings and offsets. However, the flexibility of matching through the use of regular expressions may involve repetitive matching inspections and resource occupation.

General regular expression search repeatedly matches patterns and character strings with respect to a list of regular expressions, and a search node of each regular expression is configured by using a general automata algorithm, regardless of characteristics of the regular expressions. This contains the following limitations.

First, since the number of policies is proportional to the number of nodes, a tree search speed may increase exponentially. Therefore, the number of operation polices is restricted so as to secure performance. Second, the general regular expression search is affected by a pattern having high complexity in a regular expression syntax. If using a syntax in which matching such as * or ? is frequent, matching frequency increases and thus an overall search speed is reduced. In particular, if such patterns repeatedly appear in several regular expressions, excessive resource occupation occurs during matching. In order to overcome such problems, an optimization process has been performed to extract a policy including patterns causing recursive matching in a regular expression syntax and convert the corresponding patterns into a format having low complexity. However, such an optimization process is inefficient because a part of the optimization process is manually performed and it is difficult to uniformly apply to all policies.

### SUMMARY OF THE INVENTION

One or more embodiments of the present invention include an apparatus and a method for enhancing regular expression search performance through a cost-based optimization technique, which generate a unified regular expression search tree, converts a regular expression inspection structure, which is most burdened during matching, from an individual policy matching structure to a multi-pattern structure, and determines matching or non-matching of multi-patterns through a single matching attempt.

One or more embodiment of the present invention include an apparatus and a method for enhancing regular expression search performance through a cost-based optimization technique, splitting, unifying, and optimization processes capable of efficiently configuring each node are added when a regular expression search tree is configured.

According to one or more embodiments, an apparatus for enhancing regular expression search performance through a cost-based optimization technique includes: a policy database that stores a malicious payload detection rule including a regular expression character string; a regular expression extraction processor that generates a group of regular expression character strings included in each policy from the policy database; a regular expression fragment processor that splits each of the regular expression character strings extracted by the regular expression extraction processor in accordance with a fragmentation rule, unifies regular expression fragments, and generates a regular expression fragment table; a regular expression normalization processor that generates an optimized regular expression fragment table by performing an optimization process on each of the regular expression fragments of the regular expression fragment table generated by the regular expression fragment processor; a cost calculation engine processor that determines a cost for each of the regular expression fragments by applying a sample traffic to the regular expression fragment table optimized by the regular expression normalization processor; a decision tree generation processor that generates a decision tree based on cost information calculated by the cost calculation engine processor with respect to each fragment of the regular expression fragment table optimized by the regular expression normalization processor; and a pattern matching engine processor that configures a search engine performing policy pattern matching by applying the decision tree.

The regular expression extraction processor may load entire policies of the policy database, determine whether a regular expression option is included with respect to each of the entire policies, and, when the regular expression option is determined as being included, add the regular expression option to a list of regular expressions to generate the group of regular expression character strings.

The regular expression fragment processor may split each of the regular expression character strings included in the group of regular expression character strings into fragments by applying a fragmentation rule, when overlapped fragments do not exist, the regular expression fragment processor may add the overlapped fragments to the regular expression fragment table, and when overlapped fragments exist, the regular expression fragment processor may unify the overlapped fragments and generates the regular expression fragment table.

The regular expression normalization processor may inspect each fragment of the regular expression fragment table and generates the optimized fragment table by performing optimization to remove dependency and complexity.

The cost calculation engine processor may apply a packet stream as the sample traffic to the regular expression fragment table optimized by the regular expression normalization processor, record matching or non-matching of the packet stream, calculate a matching cost for each fragment based on the corresponding matching result, and determine a cost for each regular expression fragment.

The cost calculation engine processor may apply a network traffic as the sample traffic to the regular expression fragment table optimized by the regular expression normalization processor, record matching or non-matching of the network traffic, calculate a matching cost for each fragment based on the corresponding matching result, and determine a cost for each regular expression fragment.

According to one or more embodiments, a method for enhancing regular expression search performance through a cost-based optimization technique includes: (A) by a regular expression extraction processor, generating a group of regular expression character strings included in each policy from a policy database; (B) by a regular expression fragment processor, splitting each of the regular expression character strings extracted by the regular expression extraction processor in accordance with a fragmentation rule, unifying regular expression fragments, and generating a regular expression fragment table; (C) by a regular expression normalization processor, generating an optimized regular expression fragment table by performing an optimization process on each of the regular expression fragments of the regular expression fragment table generated by the regular expression fragment processor; (D) by a cost calculation engine processor, determining a cost for each of the regular expression fragments by applying a sample traffic to the regular expression fragment table optimized by the regular expression normalization processor; (E) by a decision tree generation processor, generating a decision tree based on cost information calculated by the cost calculation engine processor with respect to each fragment of the regular expression fragment table optimized by the regular expression normalization processor; and (F) by a pattern matching engine processor, configuring a search engine performing policy pattern matching by applying the decision tree.

A may include: (A-1) by the regular expression extraction processor, loading entire policies of the policy database; and (A-2) determining whether a regular expression option is included with respect to each of the entire policies, and, when the regular expression option is determined as being included, adding the regular expression option to a list of regular expressions to generate the group of regular expression character strings.

(B) may include: (B-1) by the regular expression fragment processor, splitting each of the regular expression character strings included in the group of regular expression character strings into fragments by applying a fragmentation rule; (B-2) by the regular expression fragment processor, determining whether the split fragments overlap fragments split from other regular expressions; (B-3) when the regular expression fragment processor determines in (B-2) that overlapped fragments do not exist, adding the overlapped fragments to the regular expression fragment table and generating the regular expression fragment table, and (B-4) when the regular expression fragment processor determines in (B-2) that when overlapped fragments exist, unifying the overlapped fragments and generating the regular expression fragment table.

(c) may include inspecting each fragment of the regular expression fragment table and generating the optimized fragment table by performing optimization to remove dependency and complexity.

(D) may include: (D-1) by the cost calculation engine processor, applying a packet stream as the sample traffic to the regular expression fragment table optimized by the regular expression normalization processor; (D-2) by the cost calculation engine processor, recording matching or non-matching of the packet stream; (D-3) by the cost calculation engine processor, calculating a matching cost for each fragment based on the corresponding matching result, and determining a cost for each regular expression fragment; (D-4) by the cost calculation engine processor, applying a network traffic as the sample traffic to the regular expression fragment table optimized by the regular expression normalization processor; (D-5) by the cost calculation engine processor, recording matching or non-matching of the network traffic; and (D-6) by the cost calculation engine processor, calculating a matching cost for each fragment based on the corresponding matching result, and determining a cost for each regular expression fragment.

(F) may include: (F-1) by the pattern matching engine processor, when a search option except for the regular expression exists with respect to each policy stored in the policy database, extracting corresponding information; (F-2) by the pattern matching engine processor, unifying regular expression decision trees generated based on the regular expression option; (F-3) by the pattern matching engine processor, configuring a search engine by unifying the information extracted in (F-1) and the regular expression decision tree unified in (F-2) and loading the search engine on a memory; and (F-4) by the pattern matching engine processor, performing attack matching upon inflow of a packet.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a configuration diagram of an apparatus for enhancing regular expression search performance through a cost-based optimization technique, according to an embodiment of the present invention;

FIG. 2 is a flowchart of a method for enhancing regular expression search performance through a cost-based optimization technique, according to an embodiment of the present invention;

FIG. 3 is a detailed flowchart of processes from a regular expression group generating process to an optimization process;

FIG. 4 is a detailed flowchart of a cost determining process for a regular expression fragment and a decision tree generating process; and

FIG. 5 is a detailed flowchart of a search engine configuring process.

### DESCRIPTION OF THE PREFERRED EMBODIMENTS

Hereinafter, exemplary embodiments of the present invention will be described in detail with reference to the accompanying drawings.

The terms used in the present specification are merely used to describe particular embodiments, and are not intended to limit the present invention. An expression used in the singular encompasses the expression in the plural, unless it has a clearly different meaning in the context. In the present specification, it is to be understood that terms such as “including” or “having”, etc., are intended to indicate the existence of the features, numbers, steps, actions, components, parts, or combinations thereof disclosed in the specification, and are not intended to preclude the possibility that one or more other features, numbers, steps, actions, components, parts, or combinations thereof may exist or may be added.

Also, while describing the present invention, detailed descriptions about related well-known functions or configurations that may diminish the clarity of the points of the present invention are omitted.

The present invention provides an apparatus and a method for enhancing regular expression search performance through a cost-based optimization technique, which generate a unified regular expression search tree, converts a regular expression inspection structure, which is most burdened during matching, from an individual policy matching structure to a multi-pattern structure, and determines matching or non-matching of multi-patterns through a single matching attempt.

Also, the present invention is directed to solve the existing problems by adding splitting, unifying, and optimization processes capable of efficiently configuring each node when a regular expression search tree is configured.

(1) A first step for optimizing a node is to obtain a group of regular expression in entire policies. (2) A second step is to perform fragmentation on a regular expression character string into regular expressions of a smaller unit so as to configure a node of a search tree. (3) A third step is to unify overlapped fragments with respect to each split fragment, inspect a regular expression having high complexity (high matching frequency), and perform an optimization process of converting the regular expression in a direction of low complexity. (4) A fourth step is to perform sample traffic matching to a table including a group of unique fragments and determine costs based on the matching result and frequency. (5) A fifth step is to provide derived cost information to a decision tree algorithm and generate a decision tree.

The newly configured decision tree is configured as an efficient node through a stepwise optimization process. Several functional improvements can be expected. By minimizing dependency between nodes, the nodes can be independently distinguished from each other, thereby reducing unnecessary node search. This results in an improvement in matching speed. Also, an independent node structure ensures constant search performance, regardless of the number of policies or complexity. In particular, in the case of a node having high complexity, a depth at which a matching node is disposed during an optimization process can be constantly disposed by an algorithm rule. Thus, when a policy is added and changed, the influence of a system can also be consistent.

A cost calculation reflected by learning sample traffic data and traffic environment information input to an actual network is the same policy, but a decision tree having a different result may be generated according to a difference in traffic environments. This enables network-oriented efficient matching based on an environment where a system is installed rather than the same inflexible detection structure, regardless of operation environments of existing equipment.

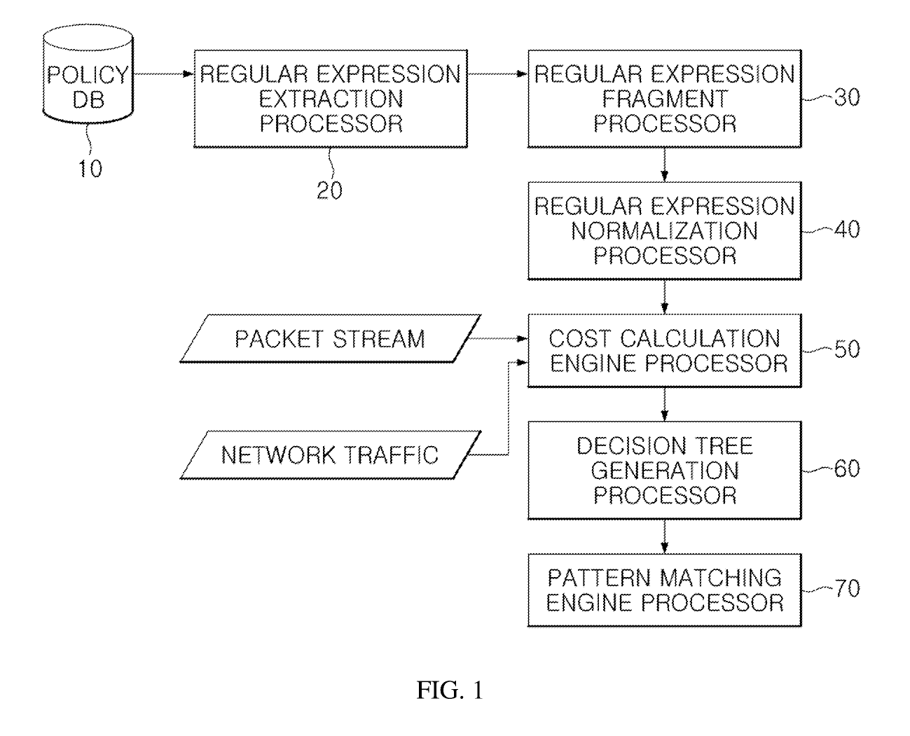

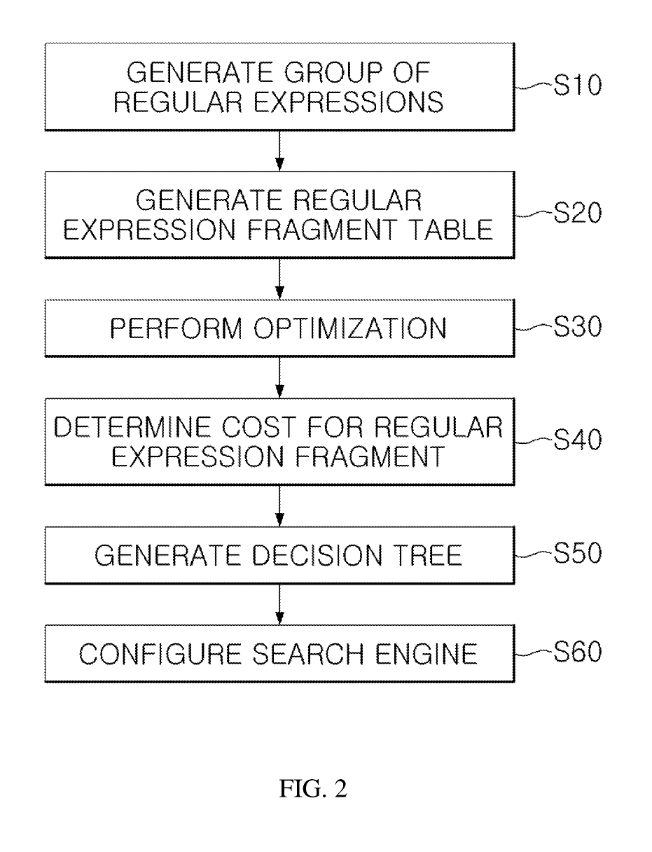

FIG. 1 is a configuration diagram of an apparatus for enhancing regular expression search performance through a cost-based optimization technique, according to an embodiment of the present invention, and FIG. 2 is a flowchart of a method for enhancing regular expression search performance through a cost-based optimization technique, according to an embodiment of the present invention.

Referring to FIG. 1, an apparatus for enhancing regular expression search performance through a cost-based optimization technique, according to an embodiment of the present invention, includes a policy database 10, a regular expression extraction processor 20, a regular expression fragment processor 30, a regular expression normalization processor 40, a cost calculation engine processor 50, a decision tree generation processor 60, and a pattern matching engine processor 70.

The policy database 10 stores a malicious payload detection rule including regular expression character strings.

The regular expression extraction processor 20 generates a group of regular expression character strings included in each policy from the policy database 10 and performs a regular expression group generating process S10 of FIG. 2.

The regular expression fragment processor 30 performs a regular expression fragment table generating process S20 by splitting each regular expression extracted by the regular expression extraction processor 20 in accordance with a fragmentation rule, unifying regular expression fragments when the regular expression fragments overlapped through a plurality of policies exist, and generating one regular expression fragment table.

The regular expression normalization processor 40 performs a regular expression normalization process of performing an optimization process by removing dependency and calculating complexity with respect to each regular expression fragment split by the regular expression fragment processor 30. This corresponds to an optimization process S30 of FIG. 2.

The cost calculation engine processor 50 performs a cost determining process S40 of FIG. 2 on a regular expression fragment by performing data matching of a packet stream or a network traffic on the optimized regular expression fragment table and determining a cost for each regular expression fragment according to a result of the data matching.

The packet stream refers to a sample traffic file that is available in the cost calculating process by the cost calculation engine processor 50.

The network traffic refers to a traffic input in real time when a system utilizes a network environment. The cost calculation engine processor 50 may selectively use the packet stream or the network traffic as cost calculation application data during the cost calculation process.

The decision tree generation processor 60 generates a decision tree by applying a decision tree algorithm based on the group of regular expression fragments optimized by the regular expression normalization processor 40 and cost information calculated with respect to each fragment by the cost calculation engine processor 50. This corresponds to a decision tree generation process S50.

The pattern matching engine processor 70 configures a search engine performing policy pattern matching by applying the decision tree. This corresponds to a search engine configuring process S60 of FIG. 2.

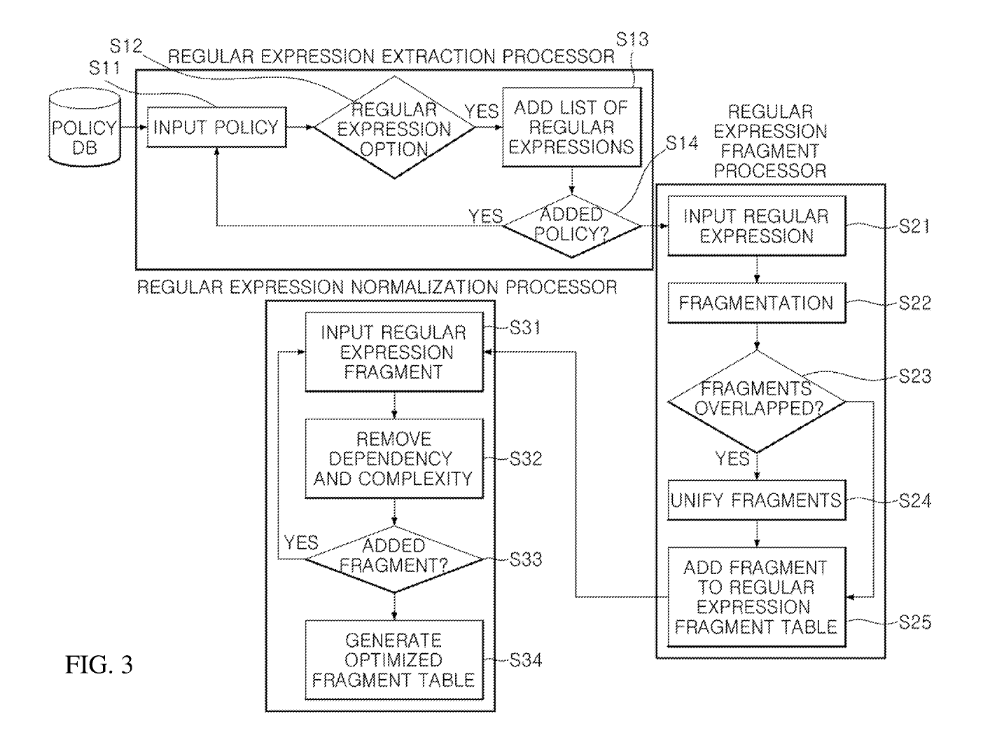

FIG. 3 is a detailed flowchart of processes from the regular expression group generating process to the optimization process.

Referring to FIG. 3, in the processes from the regular expression group generating process to the optimization process, the regular expression extraction processor 20 loads entire policies from the policy database 10 (S11).

Then, the regular expression extraction processor 20 determines whether a regular expression option is included with respect to each of the entire policies loaded from the policy database 10 (S12).

When the regular expression extraction processor 20 determines that the regular expression option is included, the regular expression extraction processor 20 adds the regular expression option to a list of regular expressions (S13) and performs regular expression option inspection on the entire policies (S14).

On the other hand, the regular expression fragment processor 30 receives the list of regular expressions from the regular expression extraction processor 20 (S21) and splits each regular expression into one or more fragments by applying a fragmentation rule to each regular expression included in the list of regular expressions (S22).

The fragment is a regular expression composed of one or more regular expression syntaxes. The fragmentation rule determines the fragment based on uniqueness so as to minimize repetitive search when a tree is configured with nodes.

The regular expression fragment processor 30 inspects whether fragments overlapped in other regular expressions exist with respect to the split fragment (S23).

When the fragments overlapped in other regular expressions exist with respect to the split fragment, the regular expression fragment processor 30 unifies the overlapped fragments (S24).

On the other hand, when the fragments overlapped in other regular expressions do not exist with respect to the split fragment, the regular expression fragment processor 30 adds fragment information to the regular expression fragment table (S25).

Through the above processes, the regular expression fragment processor 30 performs fragmentation on the entire regular expressions to generate a regular expression fragment table in which unique fragment information is collected.

Then, the regular expression normalization processor 40 receives information on each regular expression fragment from the regular expression fragment processor 30 (S31).

The regular expression normalization processor 40 inspects the regular expression fragment received from the regular expression fragment processor 30 and performs optimization to remove dependency and complexity (S32).

Then, the regular expression normalization processor 40 generates an optimized fragment table by performing optimization on the entire fragments included in the regular expression fragment table (S33). The fragment table supports multi-pattern search by reflecting regular expressions that are in not a single policy but a plurality of policies.

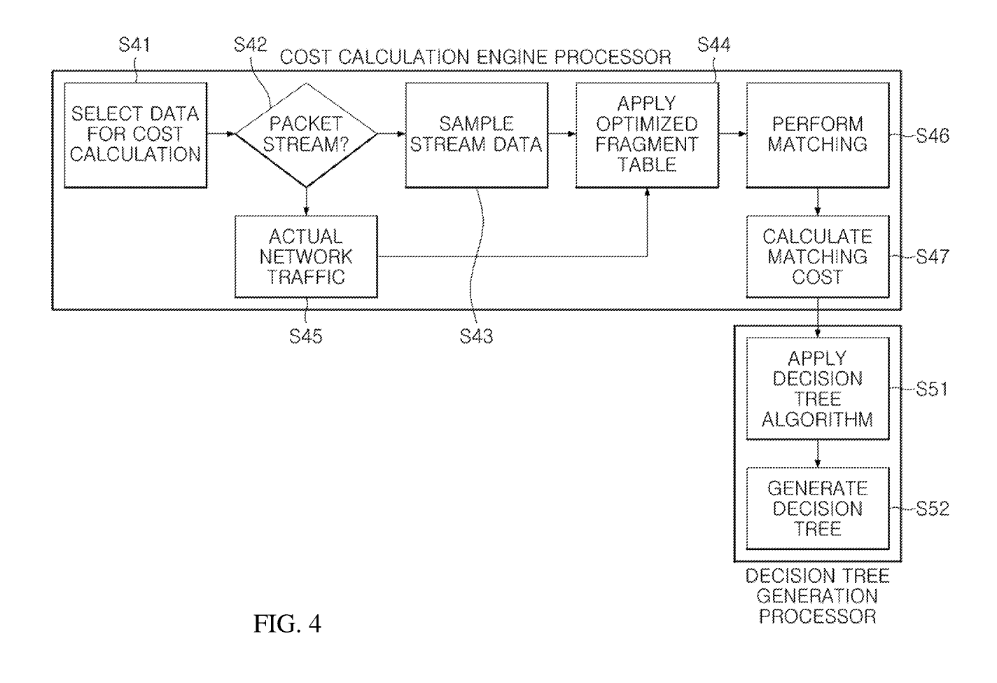

FIG. 4 is a detailed flowchart of the cost determining process for the regular expression fragment and the decision tree generating process.

Referring to FIG. 4, in the cost determining process for the regular expression fragment and the decision tree generating process of FIG. 2, the cost calculation engine processor 50 selects data to be used upon cost calculation, that is, a sample traffic type (S41). At this time, as the sample traffic type, a packet stream may be selected as a sample traffic file (S42, S43).

When a system utilizes a network environment, the cost calculation engine processor 50 may select a network traffic, which is input in real time, as the traffic type (S45).

Then, the cost calculation engine processor 50 loads the optimized fragment table generated through regular expression normalization (S44).

The cost calculation engine processor 50 applies a sample traffic to the optimized fragment table and records matching or non-matching of the sample traffic (S46).

When a matching result for the entire sample traffics is derived, the cost calculation engine processor 50 calculates a matching cost for each fragment based on the corresponding matching result (S47).

The decision tree generation processor 60 transmits matching cost information to the decision tree algorithm (S51) and generates a regular expression decision tree in which each fragment is configured with nodes (S52).

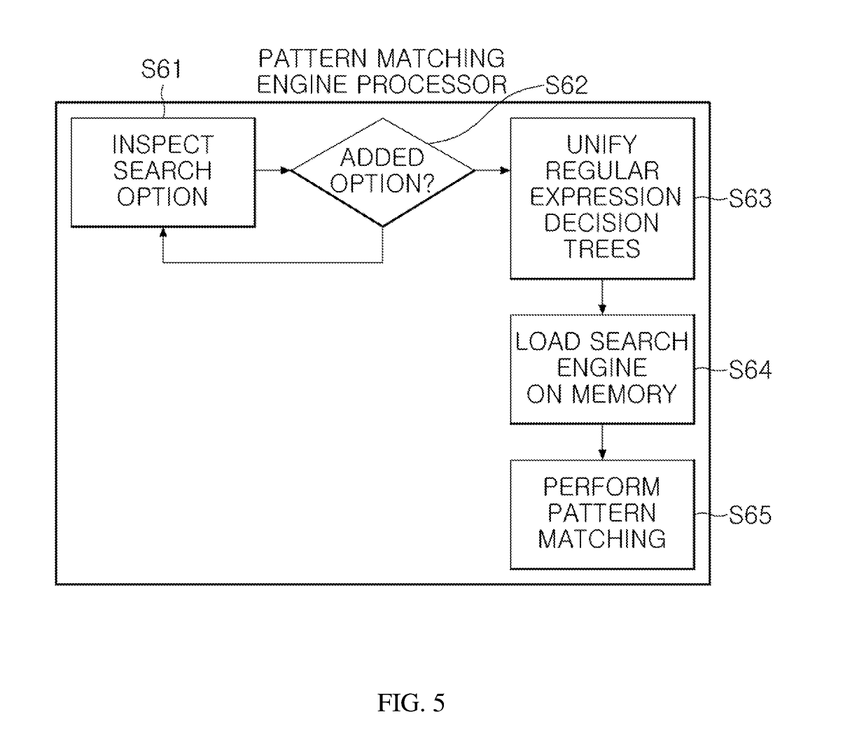

FIG. 5 is a detailed flowchart of a search engine configuring process.

Referring to FIG. 5, in the search engine configuring process of FIG. 2, when a search option except for the regular expression exists with respect to each policy stored in the policy database 10, the pattern matching engine processor 70 extracts corresponding information (S61, S62).

The pattern matching engine processor 70 unifies regular expression decision trees generated based on the regular expression option (S63).

The pattern matching engine processor 70 configures a search engine by unifying the information extracted in operations S61 and S62 and the regular expression decision tree unified in operation S63 and loads the search engine on a memory (S64).

Then, the pattern matching engine processor 70 performs attack matching upon inflow of a packet (S65).

According to one or more embodiments of the present invention, it is possible to achieve an efficient matching structure in which a single process determines matching or non-matching of multi-patterns through the decision tree generated by unifying the entire regular expression.

According to one or more embodiments, the matching speed upon packet attack matching is increased by improving the regular expression search tree.

According to one or more embodiments, it is possible to enhance a performance structure that is inversely proportional to the number of existing policies in the regular expression fragment optimizing process.

Furthermore, according to one or more embodiments, the generation of the search tree through the matching cost calculation may minimize the degree of system performance influence upon inflow of patterns having high complexity.

Moreover, according to one or more embodiments, there is provided a search structure adaptive to a network environment, in which a system is installed, through an actual network traffic application function to the matching cost calculation.

Although preferred embodiments of the present invention have been described for illustrative purposes, those skilled in the art will appreciate that various modifications, additions and substitutions are possible, without departing from the scope and spirit of the invention as disclosed in the accompanying claims. Therefore, the embodiments of the present invention are disclosed only for illustrative purposes and should not be construed as limiting the present invention.

What is claimed is:

1. An apparatus for enhancing regular expression search performance through a cost-based optimization technique, the apparatus comprising:
a policy database that stores a malicious payload detection rule including a regular expression character string;
a regular expression extraction processor that generates a group of regular expression character strings included in each policy from the policy database;
a regular expression fragment processor that splits each of the regular expression character strings extracted by the regular expression extraction processor in accordance with a fragmentation rule, unifies regular expression fragments, and generates a regular expression fragment table;
a regular expression normalization processor that generates an optimized regular expression fragment table by performing an optimization process on each of the regular expression fragments of the regular expression fragment table generated by the regular expression fragment processor;
a cost calculation engine processor that determines a cost for each of the regular expression fragments by applying a sample traffic to the regular expression fragment table optimized by the regular expression normalization processor;
a decision tree generation processor that generates a decision tree based on cost information calculated by the cost calculation engine processor with respect to each fragment of the regular expression fragment table optimized by the regular expression normalization processor; and
a pattern matching engine processor that configures a search engine performing policy pattern matching by applying the decision tree.

2. The apparatus of claim 1, wherein the regular expression extraction processor loads entire policies of the policy database, determines whether a regular expression option is included with respect to each of the entire policies, and, when the regular expression option is determined as being included, adds the regular expression option to a list of regular expressions to generate the group of regular expression character strings.

3. The apparatus of claim 1, wherein the regular expression fragment processor splits each of the regular expression character strings included in the group of regular expression character strings into fragments by applying a fragmentation rule,
when overlapped fragments do not exist, the regular expression fragment processor adds the overlapped fragments to the regular expression fragment table, and
when overlapped fragments exist, the regular expression fragment processor unifies the overlapped fragments and generates the regular expression fragment table.

4. The apparatus of claim 1, wherein the regular expression normalization processor inspects each fragment of the regular expression fragment table and generates the optimized fragment table by performing optimization to remove dependency and complexity.

5. The apparatus of claim 1, wherein the cost calculation engine processor applies a packet stream as the sample traffic to the regular expression fragment table optimized by the regular expression normalization processor, records matching or non-matching of the packet stream, calculates a matching cost for each fragment based on the corresponding matching result, and determines a cost for each regular expression fragment.

6. The apparatus of claim 1, wherein the cost calculation engine processor applies a network traffic as the sample traffic to the regular expression fragment table optimized by the regular expression normalization processor, records matching or non-matching of the network traffic, calculates a matching cost for each fragment based on the corresponding matching result, and determines a cost for each regular expression fragment.

7. A method for enhancing regular expression search performance through a cost-based optimization technique, the method comprising:
(A) by a regular expression extraction processor, generating a group of regular expression character strings included in each policy from a policy database;
(B) by a regular expression fragment processor, splitting each of the regular expression character strings extracted by the regular expression extraction processor in accordance with a fragmentation rule, unifying regular expression fragments, and generating a regular expression fragment table;
(C) by a regular expression normalization processor, generating an optimized regular expression fragment table by performing an optimization process on each of the regular expression fragments of the regular expression fragment table generated by the regular expression fragment processor;
(D) by a cost calculation engine processor, determining a cost for each of the regular expression fragments by applying a sample traffic to the regular expression fragment table optimized by the regular expression normalization processor;
(E) by a decision tree generation processor, generating a decision tree based on cost information calculated by the cost calculation engine processor with respect to each fragment of the regular expression fragment table optimized by the regular expression normalization processor; and
(F) by a pattern matching engine processor, configuring a search engine performing policy pattern matching by applying the decision tree.

8. The method of claim 7, wherein A comprises:
(A-1) by the regular expression extraction processor, loading entire policies of the policy database; and
(A-2) determining whether a regular expression option is included with respect to each of the entire policies, and, when the regular expression option is determined as being included, adding the regular expression option to a list of regular expressions to generate the group of regular expression character strings.

9. The method of claim 7, wherein (B) comprises:
(B-1) by the regular expression fragment processor, splitting each of the regular expression character strings included in the group of regular expression character strings into fragments by applying a fragmentation rule;
(B-2) by the regular expression fragment processor, determining whether the split fragments overlap fragments split from other regular expressions;
(B-3) when the regular expression fragment processor determines in (B-2) that overlapped fragments do not exist, adding the overlapped fragments to the regular expression fragment table and generating the regular expression fragment table, and
(B-4) when the regular expression fragment processor determines in (B-2) that when overlapped fragments exist, unifying the overlapped fragments and generating the regular expression fragment table.

10. The method of claim 7, wherein (c) comprises inspecting each fragment of the regular expression fragment table and generating the optimized fragment table by performing optimization to remove dependency and complexity.

11. The method of claim 7, wherein (D) comprises:
(D-1) by the cost calculation engine processor, applying a packet stream as the sample traffic to the regular expression fragment table optimized by the regular expression normalization processor;
(D-2) by the cost calculation engine processor, recording matching or non-matching of the packet stream;
(D-3) by the cost calculation engine processor, calculating a matching cost for each fragment based on the corresponding matching result, and determining a cost for each regular expression fragment;
(D-4) by the cost calculation engine processor, applying a network traffic as the sample traffic to the regular expression fragment table optimized by the regular expression normalization processor;
(D-5) by the cost calculation engine processor, recording matching or non-matching of the network traffic; and
(D-6) by the cost calculation engine processor, calculating a matching cost for each fragment based on the corresponding matching result, and determining a cost for each regular expression fragment.

12. The method of claim 7, wherein (F) comprises:
(F-1) by the pattern matching engine processor, when a search option except for the regular expression exists with respect to each policy stored in the policy database, extracting corresponding information;
(F-2) by the pattern matching engine processor, unifying regular expression decision trees generated based on the regular expression option; and
(F-3) by the pattern matching engine processor, configuring a search engine by unifying the information extracted in (F-1) and the regular expression decision tree unified in (F-2) and loading the search engine on a memory; and
(F-4) by the pattern matching engine processor, performing attack matching upon inflow of a packet.
